(19) United States
(12) Patent Application Publication
(10) Pub. No.: US 2006/0045341 A1
(43) Pub. Date: Mar. 2, 2006

(54) Apparatus and method for high-speed character recognition

(75) Inventor: Jong-hyon Yi, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/210,905

(22) Filed: Aug. 25, 2005

(30) Foreign Application Priority Data
Aug. 31, 2004 (KR) 10-2004-0068921

(51) Int. Cl. G06K 9/18

(52) U.S. Cl. 382/182

(57) ABSTRACT

An apparatus and a method for high-speed character recognition are disclosed. The character recognition method includes receiving a bit-stream decoded base on a symbol matching encoding scheme where the bit-stream including a symbol dictionary and a symbol information which is information of symbols included in an original image; decoding the symbol dictionary included in the bit-stream; performing a character recognition process of each of plural of symbols included in the decoded symbol dictionary; decoding the symbol information after completing the character recognition process; and generating a text file of the original image by using the result of the character recognition process and the decoded symbol information.

### CROSS-REFERENCE TO RELATED APPLICATION

This application claims the benefit of Korean Patent Application No. 10-2004-0068921, filed on Aug. 31, 2004, in the Korean Intellectual Property Office, the disclosure of which is incorporated herein by reference.

### BACKGROUND OF THE INVENTION

1. Field of the Invention

The present invention relates to an apparatus and a method for high-speed character recognition; more particularly, to an apparatus and a method for recognizing a character included in a binary image encoded based on a symbol matching encoding scheme.

2. Description of the Related Art

A binary image is commonly encoded based on encoding schemes including a modified Huffman (MH), a modified READ (MR), a modified modified READ (MMR), a joint bi-level image experts group 1 (JBIG 1) and a joint bi-level image experts group 2 (JBIG 2). Among the above mentioned encoding schemes, the MR and the MMR encoding schemes are used for a Group-3 (G3) fax and a Group-4 (G4) fax. Also, the JBIG1 is an arithmetic encoding algorithm based on a context and the JBIG2 is a symbol matching encoding algorithm.

Hereinafter, the symbol matching encoding algorithm is explained in brief. At first, a symbol is extracted from the binary image, where the symbol may be a character included in the binary image. After extracting, a dictionary or a library is searched to find a symbol similar to the extracted symbol. If the similar symbol is found in the dictionary, the extracted symbol is encoded based on index information of the similar symbol in the dictionary. If there is no symbol similar to the extracted symbol in the dictionary, the extracted symbol is registered in the dictionary and encoded. After encoding the symbol included in the binary image, a symbol extracted image of the binary image is encoded based on an additional encoding method. The symbol extracted image is a part of the binary image remained after extracting symbols from the binary image.

Meanwhile, a conventional method for recognizing characters included in data compressed based on the symbol matching encoding scheme is explained. At first, the compressed data is decoded to restore an original image. After decoding, pretreatment processes are performed on the restored original image, the pretreatment processes are a noise filtering and an edge smoothing. And, a symbol or a character is extracted from the pretreated original image and the extracted character is recognized by using a character recognition device such as an optical character recognition (OCR).

As mentioned above, the conventional character recognition process is time-consuming process. That is, according to the conventional character recognition method, the character included in the binary image is recognized after completing processes of decompressing the compressed data, performing pretreatment processes, extracting the character and recognition the extracted character. Furthermore, in the conventional character recognition method, the process of character recognition is repeatedly performed as many as the number of characters included in the binary image. Accordingly, the conventional character recognition method spends a long time for character recognition.

Also, the conventional character recognition method requires large quantity of memory space since the conventional character recognition method needs to perform several processes for character recognition.

### SUMMARY OF THE INVENTION

Additional aspects and/or advantages of the invention will be set forth in part in the description which follows and, in part, will be apparent from the description, or may be learned by practice of the invention.

Accordingly, the present general inventive concept has been made to solve the above-mentioned and/or problems, and an aspect of the present general inventive concept is to provide an apparatus and a method for rapidly recognizing characters included in a binary image compressed based on a symbol matching encoding scheme.

In accordance with an aspect of the present invention, there is provided a character recognition method, including receiving a bit-stream which includes a symbol dictionary decoded based on a symbol matching encoding scheme and a symbol information which is information of symbols included in an original image; decoding the symbol dictionary included in the bit-stream; performing a character recognition process of each of plural of symbols included in the decoded symbol dictionary; decoding the symbol information after completing the character recognition process; and generating a text file of the original image by using the result of the character recognition process and the decoded symbol information.

The symbol information includes location information and index information. The location information represents a location of a symbol in the original image and the index information is a location of a symbol in the symbol dictionary.

The character recognition method further includes generating a layer image hierarchically representing the original image restored in the decoding operation and the text file. The result of the character recognition process is outputted as a character code.

In accordance with another aspect of the present invention, there is provided a character recognition apparatus, including: a decoder to decode a symbol dictionary decoded based on a symbol matching encoding scheme and a symbol information, wherein the symbol information is information of symbols included in an original image; a character recognition unit to perform a character recognition process on each of plural of symbols included in the decoded symbol dictionary; and a text file generator to generate a text file of the original image by using the result of character recognition process and the decoded symbol information.

The character recognition apparatus further includes: a storing unit to store the symbols registered in the symbol dictionary and a character code value corresponding to each symbol.

The character recognition apparatus further includes: a layer image generator to generate a layer image (hierarchically) representing the original image restored by the decoder and the text file.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a character recognition apparatus in accordance with an embodiment of the present invention;

FIG. 2 is a flowchart showing a character recognition method in accordance with an embodiment of the present invention;

FIG. 3 is a view showing a decoded symbol dictionary by a decoder;

FIG. 4 is a view showing a result of performing character recognition process on each of plural of symbols registered in a decoded symbol dictionary;

FIG. 5 is a view showing an example of an original image;

FIG. 6 is a view showing a symbol information of the original image shown in FIG. 5;

FIG. 7 is a view showing a text file generated by a text file generator; and

FIG. 8 is a view showing a layer image generated by a layer image generator.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Certain embodiments of the present invention will be described in greater detail with reference to the accompanying drawings.

In the following description, the same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail since they would obscure the invention in unnecessary detail.

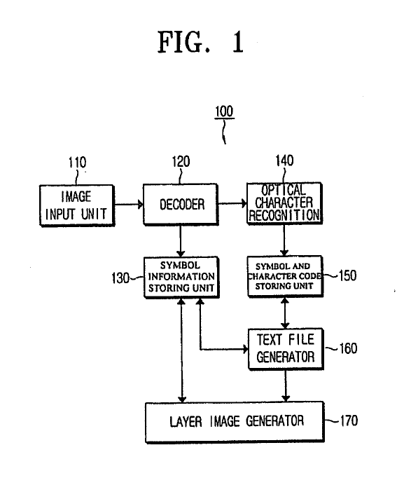

FIG. 1 is a diagram illustrating a character recognition apparatus in accordance with an embodiment of the present invention.

By referring to FIG. 1, the character recognition apparatus 100 includes an image input unit 110, a decoder 120, a symbol information storing unit 130, an optical character recognition 140, a symbol character code storing unit 150, a text file generator 160 and a layer image generator 170.

The image input unit 110 receives a bit-stream including data encoded based on a symbol matching encoding scheme from an external device. The bit-stream includes a header region and a data region. The header region includes information of data included in the data region, such as encoding information. And, the data region includes a symbol dictionary and symbol information. The symbol dictionary is a symbol set made by gathering extracted symbols and the symbol information is information of symbols included in the original image. The symbol information includes location information of the extracted symbols and index information. The location information represents a location of a symbol in the original image and the index information is a location of the symbol in the symbol dictionary.

The decoder 120 decodes the symbol dictionary and the symbol information included in the bit-stream received from the image input unit 110 and outputs the decoded data. Accordingly, the binary image decoded based on the symbol matching encoding scheme is restored to the original image. The decoder 120 temporally stores the decoded symbol dictionary and the decoded symbol information in the symbol information storing unit 130.

The OCR 140 receives the decoded symbol dictionary from the decoder 120 and performs a character recognition process on each of plural of symbols registered in the symbol dictionary. The OCR 140 may perform the character recognition process by using a pattern matching scheme or by extracting a characteristic value from the symbol and comparing the extracted characteristic value with a predetermined characteristic value assigned to each character. The OCR 140 converts a result of character recognition process to a character code and outputs the character code. The character code may be an American standard code for information interchange (ASCII) or a Unicode.

The symbol character storing unit 150 stores plural symbols registered in the symbol dictionary and the character code value corresponding to each symbol.

The text file generator 160 generates a text file of the original image by using the symbol information stored in the symbol information storing unit 130 and the character code value of each symbol stored in the symbol character storing unit 150.

The layer image generator 170 generates a layer image which hierarchically represents the generated text file from the text file generator 160 and the original image restored by the decoder 120.

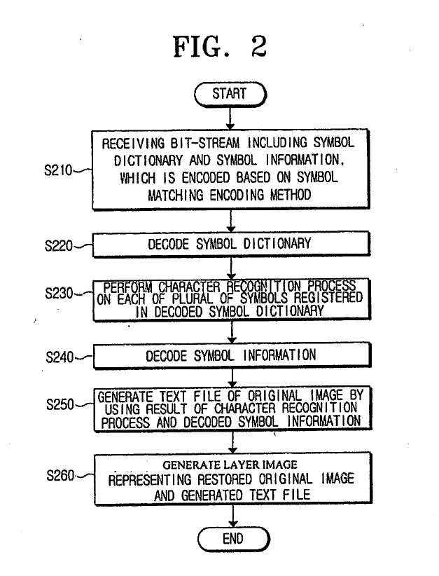

Hereinafter, a character recognition method in accordance with an embodiment of the present invention is explained in detail by referring to FIGS. 2 to 8.

FIG. 2 is a flowchart showing a character recognition method in accordance with an embodiment of the present invention.

As shown in FIG. 2, the image input unit 110 receives the bit-stream decoded based on a symbol matching encoding scheme at the operation S201. The bit-stream includes the symbol information and the symbol dictionary. As mentioned above, the symbol dictionary is a symbol set made by gathering extracted symbols and the symbol information is information of symbols included in the original image. The symbol information includes location information of the extracted symbols and index information. After receiving the bit-stream, the decoder 120 decodes the symbol dictionary include in the bit-stream at operation S220.

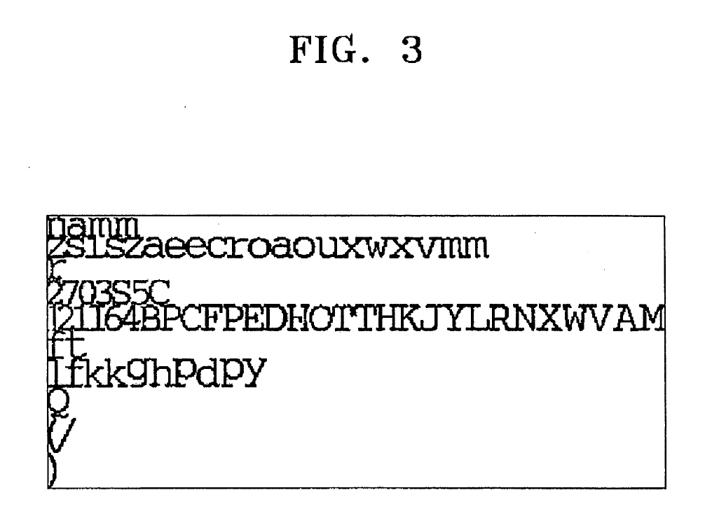

FIG. 3 is a view showing the decoded symbol dictionary by the decoder 120.

As shown in FIG. 3, plural of symbols are independently registered in the decoded symbol dictionary and symbols may be sorted based on a height and a width. The decoded symbol dictionary is stored in the symbol information storing unit 130.

The OCR 140 performs the character recognition process on each symbol of plural of symbols registered in the decoded symbol dictionary at operation S230.

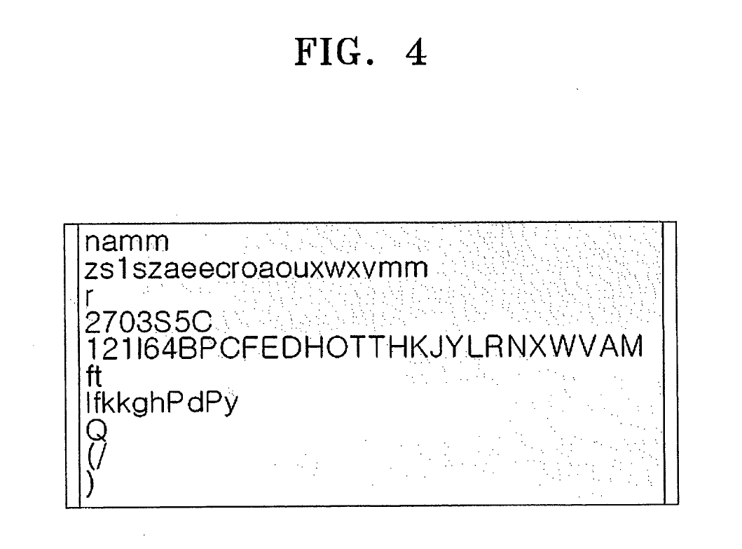

FIG. 4 show a result of character recognition process of plural of symbols registered in the decoded symbol dictionary. After completing the character recognition process at operation S230, the decoder 120 decodes the symbol information included in the bit-stream at operation S240. Accordingly, the image encoded based on the symbol matching encoding scheme is restored to the original image.

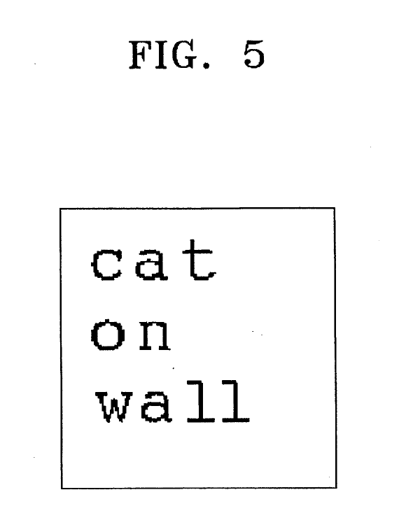

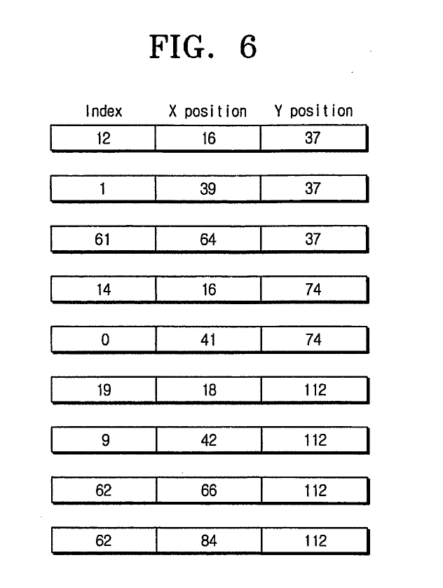

FIG. 5 show an example of the original image and FIG. 6 shows symbol information of symbols included in the original image shown in FIG. 5. As shown in FIG. 6, the symbol information includes the index information and the location information. The location information represents a location of symbol in the original image and the index information is a location of symbol in the symbol dictionary.

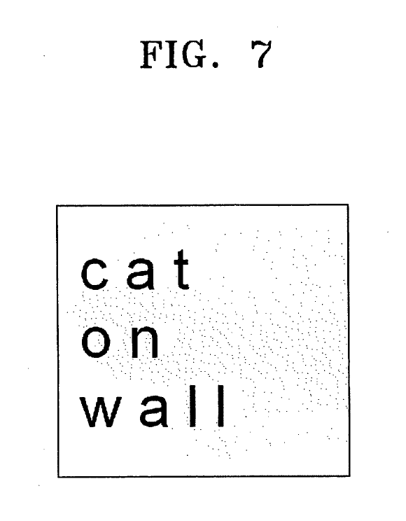

The text file generator 160 generates a text file of the original image at operation S250 by using the result of character recognition process from the operation S230 and the symbol information from the operation S240. FIG. 7 shows the text file generated in the text file generator. The text file shown in FIG. 7 is a text file for the original image shown in FIG. 5.

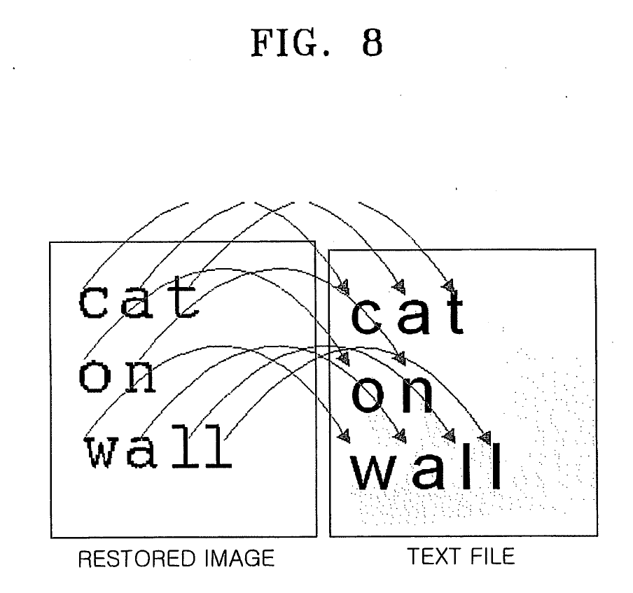

The layer image generator 170 generates the layer image at operation S260 by using the original image restored in the operation S240 and the text file generated in the operation S250. FIG. 8 shows the layer image generated by the layer image generator. As shown in FIG. 8, symbols included in the original image are matched in one-to-one manner to the symbols included in the text file.

As mentioned above, the character recognition apparatus and the method thereof in accordance with a preferred embodiment of the present invention can obtain results of the character recognition without decoding entire image to an original image. That is, in the present invention, the character recognition process is performed by using the decoded symbol dictionary. Accordingly, the pretreatment processes and the character extracting process are not necessary for character recognition process. Therefore, the character recognition apparatus and the method in accordance with a preferred embodiment can provide high-speed character recognition.

Furthermore, the character recognition apparatus and the method thereof can provide the layer image representing the character recognition result and the decoded original image hierarchically. Accordingly, the modification and the reformation can be effectively accomplished.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A character recognition method, comprising:
receiving a bit-stream, the bit-stream comprises a symbol dictionary encoded based on a symbol matching encoding scheme and a symbol information which is information of symbols included in an original image;
decoding the symbol dictionary included in the bit-stream;
performing a character recognition process of each of plural of symbols included in the decoded symbol dictionary;
decoding the symbol information; and
generating a text file of the original image by using the result of the character recognition process and the decoded symbol information.

2. The character recognition method of claim 1, wherein the symbol information comprises location information and index information, the location information representing a location of symbol in the original image, the index information being a location of the symbol in the symbol dictionary.

3. The character recognition method of claim 1, further comprising:
generating a layer image representing the original image restored in the performing operation and the text file.

4. The character recognition method of claim 1, wherein decoding the symbol information is performed after character recognition process.

5. The character recognition method of claim 3, wherein the layer image is represented hierarchically.

6. The character recognition method of claim 1, wherein in the decoding operation, the result of the character recognition process is outputted as a character code.

7. A character recognition apparatus, comprising:
a decoder to decode a symbol dictionary and a symbol information, the symbol dictionary decoded based on a symbol matching encoding scheme, the symbol information being information of symbols included in an original image;
a character recognition unit to perform a character recognition process on each of plural of symbols included in the decoded symbol dictionary; and
a text file generator to generate a text file of the original image by using the result of character recognition process and the decoded symbol information.

8. The character recognition apparatus of claim 7, wherein the symbol information comprises a location information and an index information, the location information representing a location of symbol in the original image, the index information being a location of symbol in the symbol dictionary.

9. The character recognition apparatus of claim 7, further comprising:
a storing unit to store the symbols registered in the symbol dictionary and a character code value corresponding to each symbol.

10. The character recognition apparatus of claim 7, further comprising:
a layer image generator to generate a layer image representing the original image restored by the decoder and the text file.

11. The character recognition apparatus of claim 10, wherein the layer image is represented hierarchically.

12. The character recognition apparatus of claim 7, further comprising:
a symbol information storing unit to store the symbol.

13. A character recognition method, comprising:
decoding a symbol dictionary;
decoding symbol information; and
performing a character recognition process of each of plural of symbols using the symbol dictionary.

14. The method of claim 13, wherein the symbol information comprises a location information which a location of symbol in an original image and an index information which a location of symbol in a symbol dictionary.

15. The method of claim 13, further comprising:
generating a text file of the original image by using the result of the character recognition process and the decoded symbol information.

16. A method of recognition of character, comprising:
performing character recognition of a received and decoded symbol dictionary producing a text character to symbol relationship; and
outputting a text character corresponding to a decoded received symbol using the relationship.
